(19) United States
(12) Patent Application Publication
(10) Pub. No.: US 2010/0082940 A1
(43) Pub. Date: Apr. 1, 2010

(54) INFORMATION PROCESSOR

(75) Inventors: TAKUMI NITO, Kokubunji (JP); Masashi TAKADA, Kokubunji (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/546,748

(22) Filed: Aug. 25, 2009

(30) Foreign Application Priority Data
Sep. 29, 2008 (JP) 2008-249483

(51) Int. Cl. G06F 15/76; G06F 12/08; G06F 9/02

(52) U.S. Cl. 712/28; 711/125; 711/E12.017; 712/E09.002

(57) ABSTRACT

An information processor controls accesses to a cache memory from application software programs differing in range of addresses, accesses to which are authorized. The cache memory blocks an access to an unauthorized address. In the information processor, an ID is assigned to each application software program, and the tag field of the cache memory is extended. Further, in performing “Cache Fill” (i.e. reading main memory data into the cache memory), the ID is recorded. At the time of making a cache hit judgment, the access control is performed by comparing the extended tag field with ID of an application software program group of an access requester.

### CLAIM OF PRIORITY

The Present application claims priority from Japanese application JP 2008-249483 filed on Sep. 29, 2008, the content of which is hereby incorporated by reference into this application.

### FIELD OF THE INVENTION

The present invention relates to an information processor, and particularly it relates to a cache memory used for CPU (Central Processing Unit) of a computing machine.

### BACKGROUND OF THE INVENTION

Adopted for processors of today, especially microcomputers used for embedded devices is a technique which includes: configuring a CPU core operable to conduct a generic processing, and peripheral IPs each designed for a certain processing into one chip; and constructing a system on which more than one application software program works. In such system, more than one application software program shares a region on a main memory.

An originally unintended access may be made from a CPU core in a processor to a memory region which an application software program is using owing to the following factors: (1) a bug of software origin; (2) a bug of hardware origin; (3) a temporary hardware trouble (involved with e.g. a software error owing to alpha rays); and (4) a malicious software program. Such access shall be referred to as “unauthorized address-access”. Particularly, a product failure owing to a bug of software origin often becomes a problem in embedded device applications.

Required to prevent such unauthorized address-access from exerting an adverse effect on another application software program is an access control device which sets a range of accessible addresses to block an unauthorized address-access for each application software program. Japanese Unexamined Patent Publication JP-A-2004-334410 discloses an access control device which detects and blocks an unauthorized address-access to a main memory.

### SUMMARY OF THE INVENTION

As to a computing machine system including an access control device operable to block an unauthorized address-access as described above, in the case of preparing a cache memory exclusively for each group of application software programs differing in the range of accessible addresses, an extremely large chip area is expected to be required. On that account, sometimes it is necessary to arrange a cache memory to be shared by application software programs of each group.

In a case that a cache memory is shared by groups of application software programs differing in the range of accessible addresses, the cache memory can be accessed through no access control device, and therefore an unauthorized address-access to the cache memory cannot be blocked. FIG. 1 shows an example in which an unauthorized address-access to a cache memory is made. The reference numerals 100 and 101 denote groups of application software programs differing in the range of accessible addresses, which work on CPU cores denoted by 110 and 111 respectively. The CPU cores 110 and 111 share a cache memory 120, and are linked to a main memory 150 from the cache memory 120 through a system bus 130 and an access control device 140. The numeral 200 represents a copy of datum 210 on the main memory, which can be accessed only from an application software program of the application group 100. The numeral 201 denotes a copy of datum 211 on the main memory which can be accessed only from an application software program of the application group 101. As the CPU core 110 which runs an application software program of the application group 100, and the CPU core 111 which runs an application software program of the application group 101 share the cache memory 120, not only normal accesses as indicated by arrows 220 and 221, but also unauthorized address-accesses as indicated by arrows 222 and 223 can be made.

To block an unauthorized address-access to the cache memory as described above, a mechanism of access control becomes necessary for the cache memory. The cache memory refers to a device for raising the efficiency of the computing machine system. Therefore, it is required to avoid increasing the time taken to access a cache memory when adding a mechanism of access control to the cache memory as far as possible.

Now, as a preferred embodiment of the invention herein disclosed, an information processor will be outlined below briefly. The information processor includes at least one CPU core, a cache memory, a main memory, a circuit serving to detect a domain ID assigned to an application software program which the CPU core is running, and an access control device which detects and blocks an unauthorized access to the main memory based on the domain ID and an access-destination address. The cache memory has a control circuit which records a domain ID in an extended tag field when an access to the main memory is permitted, in a hit judgment, makes a comparison between the domain ID in the extended tag field and the domain ID of the access requester, and handles the access as a cache miss when the result of the comparison shows a disagreement. Now, it is noted that the domain ID represents an ID collectively assigned to application software programs identical in the range of addresses, accesses to which are authorized.

Alternatively, the information processor may include a circuit operable to detect the domain ID of a group of application software programs which a CPU core is running, provided that the group of application software programs run by the CPU core is fixed, and a CPU core ID may be used instead of a domain ID.

The invention can realize an information processor of high reliability.

### BRIEF DESCRIPTION OF THE DRAWINGS

FIG. 1 is a diagram for explaining an example in which an unauthorized address-access is caused in a cache memory;

FIG. 2 is a diagram showing an example of system configuration in association with a first embodiment of the invention;

FIG. 3 is a diagram showing an access-permission table in an access control device;

FIG. 4 is a diagram showing the connections between a CPU core and a cache memory according to the first embodiment;

FIG. 5 is a diagram for showing the configuration of a cache memory and an action of judging a cache hit, which shows;

FIG. 6 is a flow chart of data access;

FIG. 7 is a diagram showing an example of system configuration in association with a second embodiment of the invention; and

FIG. 8 is a diagram showing the connections between a CPU core and a cache memory according to the second embodiment.

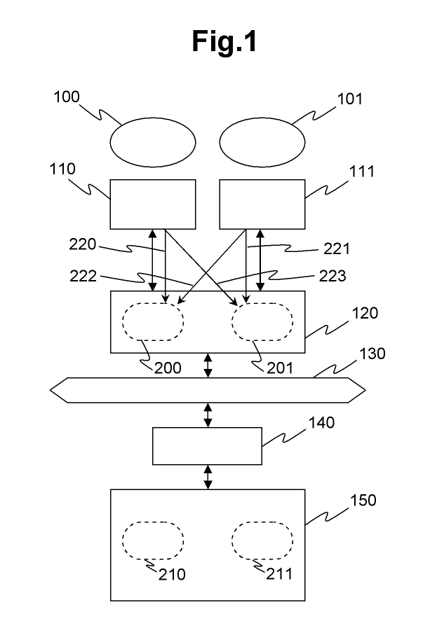

### DETAILED DESCRIPTION OF THE PREFERRED EMBODIMENTS

An information processor according to preferred embodiments of the invention will be described below with reference to the accompanying drawings. Although no special restriction is intended, circuit elements making blocks involved in the embodiment are formed on a semiconductor substrate like a bulk single-crystal silicon by a well-known semiconductor IC technique for CMOS (complementary MOS transistors), bipolar transistors and the like.

### First Embodiment

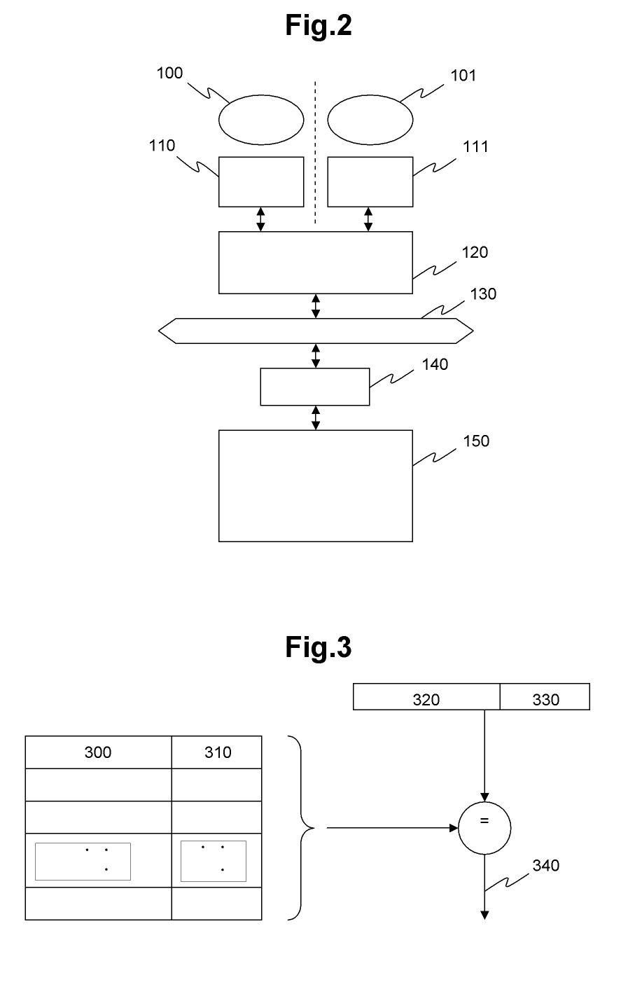

FIG. 2 shows a system configuration in association with a first embodiment. The system includes: CPU cores; a cache memory; an access control device; a main memory; and groups of application software programs working on it. The application groups 100 and 101 differ in the range of accessible addresses. Application software programs of the application group 100 work merely on the CPU core 110, whereas application software programs of the application group 101 work merely on the CPU core 111. The CPU cores 110 and 111 share the cache memory 120, and are linked from the cache memory 120 to the main memory 150 through a system bus 130 and an access control device 140.

The access control device 140 has a table as shown in FIG. 3, which contains a range 300 of access-destination addresses, and a domain ID 310 of an access requester, accesses to and from which are authorized. On receipt of a request for access to the main memory 150 through the system bus 130, the access control device 140 compares an access-destination address 320 and a domain ID 330 of an access requester with address ranges 300 of entries of the table and domain IDs 310, and then, if detecting an unauthorized access, breaks an access-permission signal 340. In this embodiment, the application software programs of the application group 100 are executed by the CPU core 110, whereas the application software programs of the application group 101 are executed by the CPU core 111. Therefore, the combinations of the application groups 100 and 101, and the CPU cores 110 and 111 are decided uniquely, and consequently the ID of each CPU core can be used as a domain ID.

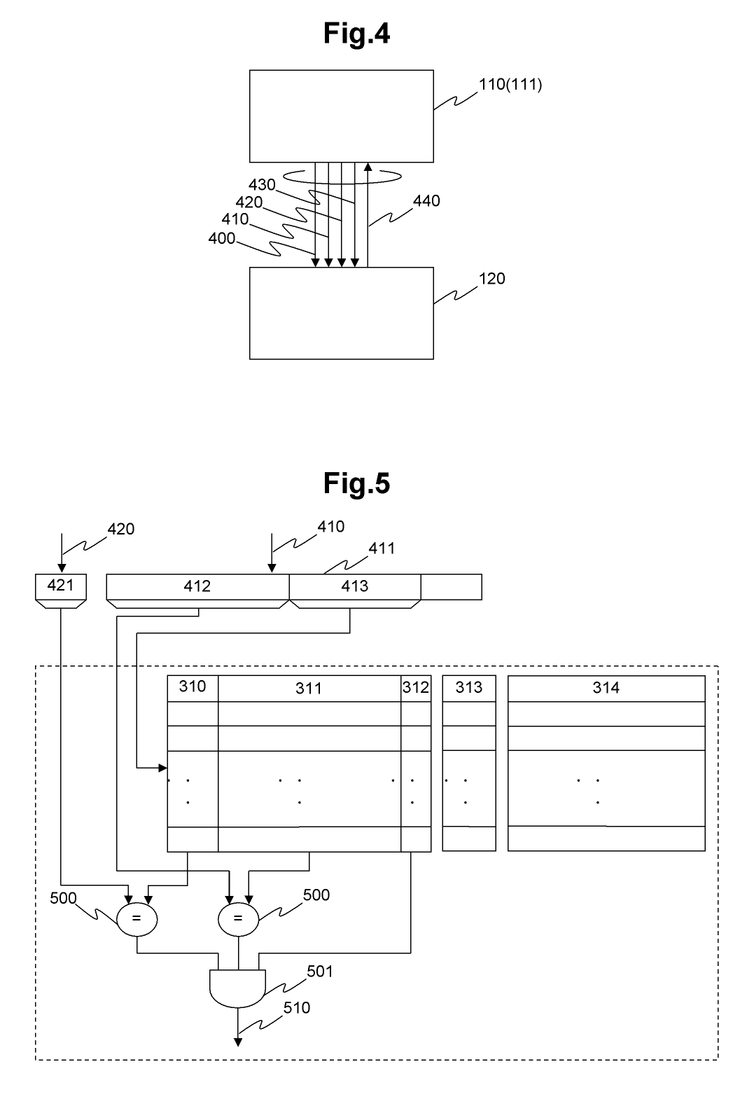

FIG. 4 shows the connections between the CPU core 110 and cache memory 120, which include a request-control line 400, an address line 410, a domain line 420, a write-data line 430 and a read-data line 440. The request-control line 400 is a signal line for transmitting a data write/read request control signal from the CPU core 110 to the cache memory 120; the address line 410 is a signal line for transmitting a destination address of a data write/read request; the domain line is a signal line for transmitting a domain ID of a data-write/read requester, which is identical with a CPU core ID in this embodiment; the write-data line is a signal line for transmitting write data; and the read-data line is a signal line for transmitting read data. The connections between the CPU core 111 and cache memory 120, between the cache memory 120 and system bus 130, between the system bus 130 and access control device 140, and between the access control device 140 and main memory 150 are arranged in the same way.

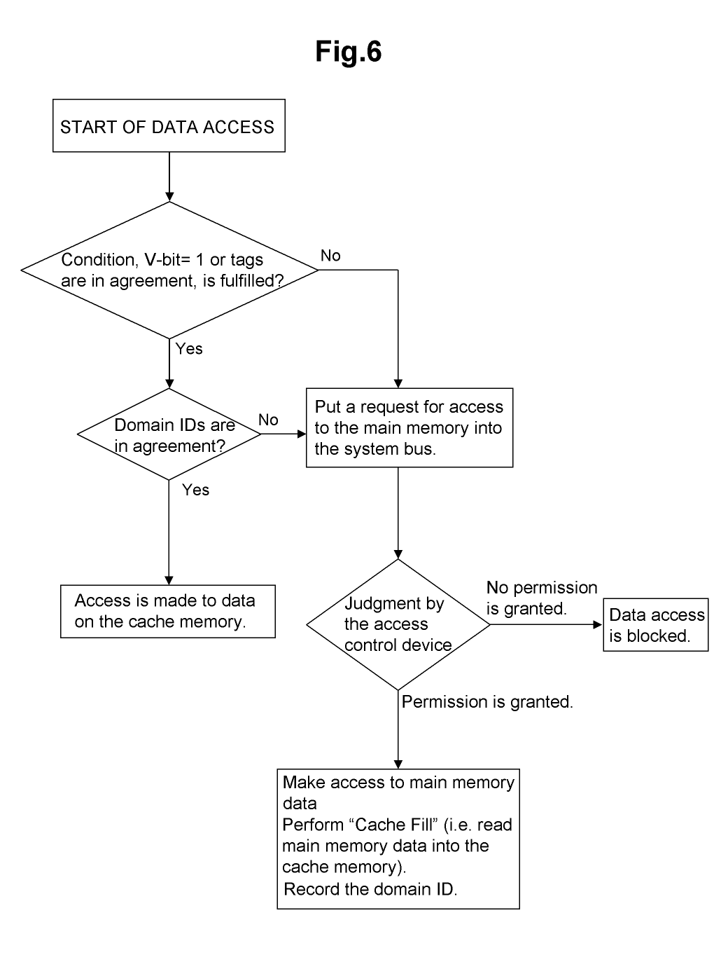

Now, a mechanism to block an unauthorized address-access in the cache memory will be explained with reference to FIGS. 5 and 6. FIG. 5 presents a schematic diagram for showing the configuration of the cache memory and an action of judging a cache hit. FIG. 6 presents a flow chart of data access. The cache memory holds, for each cache line, a tag 311, a V-bit 312 showing whether a cache line is valid or not, LRU 313 and data 314, which have been present in a conventional cache memory. As to the cache memory, the tag field thereof is extended, and in the extended tag field 310, a domain ID 421 notified by CPU core can be recorded.

On arrival of a data access request from a CPU core, a cache tag 412 and a cache entry 413 are determined from a notified address 411. The entry number of a cache line of the cache memory, where data is recorded, is identified from the cache entry 413, and then comparators 500 make comparisons between the domain ID 310 and tag 311 recorded there and a domain ID 421 and a cache tag 412 which are notified from the CPU core. Further, a logical AND circuit 501 determines a logical product of the results of the comparisons and a value of the V-bit 312, whereby a cache hit judgment is performed.

In the cache hit judgment, in a case that the V-bit has a value of zero, or the tags are in disagreement with each other, there is no data at an address targeted for the access request on the cache memory, and therefore, a request for access to the main memory is put into the system bus 130. On receipt of the request, the access control device 140 makes a judgment about the access. As a result, if it is judged to be an unauthorized address-access, the access is blocked. Otherwise, in a case that the access is permitted, data is returned from the main memory 150. When the data thus returned arrives at the cache memory after the permission of access, the returned data is recorded in the cache line indicated by the cache entry 413 together with the domain ID 421 and cache tag 412, which have been notified by the CPU core 110 concurrently with the issue of the data access request.

In the cache hit judgment, in a case that the V-bit has a value of one, and the tags and domains are both in agreement with each other, the circumstance is as follows. That is, there is data at an address targeted for the access request on the cache memory, and an access to the main memory using the same address and domain ID as the address 411 and domain ID 421 of the data access request had been attempted and permitted in the past. Under such circumstance, the access judgment is made using the address 411 and domain ID 421, and therefore the access should be permitted, which is not judged to be an unauthorized address-access. Thus, access to data on the cache memory is made.

In the cache hit judgment, in a case that the V-bit has a value of one, the tags are in agreement with each other, and the domains are in disagreement, the circumstance is as follows. That is, there is data at an address targeted for the access request on the cache memory, however it is impossible to make a judgment on whether to authorize an access to the cache memory or not. Therefore, this case is also handled as a cache miss. Then, as in the case where there is no corresponding data on the cache memory, a request for access to the main memory is put into the system bus 130, and the access control device 140 detects and blocks an unauthorized address-access.

As described above, in this embodiment, in a case that the result of the comparison between the extended tag field and CPU core ID (or domain ID) is in agreement, it shows that a like access had been permitted in the past, and therefore the access to the cache memory should be allowed. Further, in a case that the result of the comparison between the extended tag field and CPU core ID (or domain ID) is in disagreement, it is impossible for the cache memory to judge whether to permit the access or not. Thus, the same procedure as that in the case of a cache miss is executed. Then, access to the access control device and the main memory are performed instead of access to data on the cache memory. The access control device grants permission to an access which should be permitted, whereby it becomes possible to access data on the main memory. In contrast, an unauthorized address-access which should not be permitted is blocked by the access control device. It is possible to block an unauthorized address-access to the main memory as well as to the cache memory. Moreover, in comparison to a conventional cache memory, the invention just requires widening the tag field slightly in size, and therefore an overhead in terms of the time taken for access to a cache memory is small.

### Second Embodiment

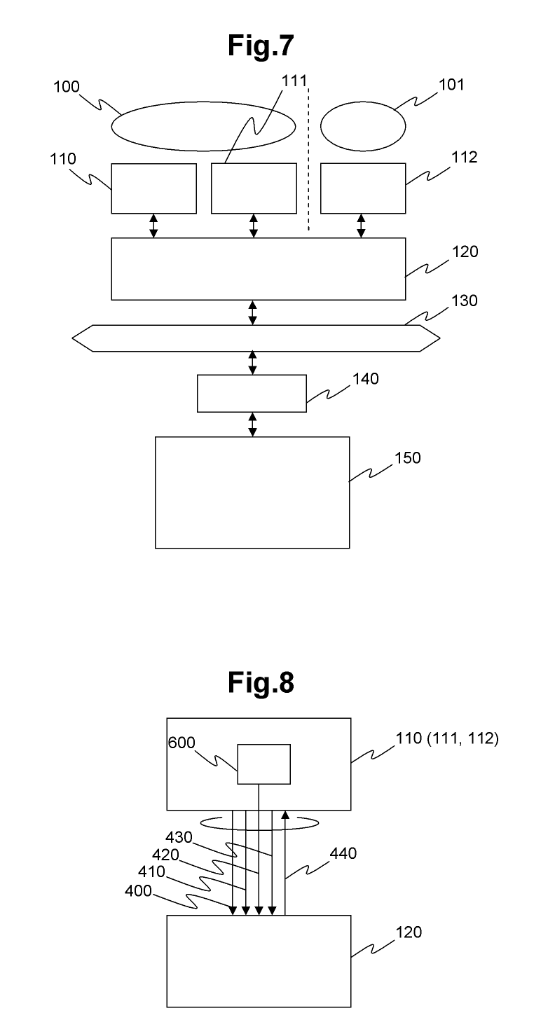

FIG. 7 shows a system configuration in association with a second embodiment. The system includes: CPU cores; a cache memory; an access control device; a main memory; and groups of application software programs working on it. The application software program groups 100 and 101 differ in the range of accessible addresses, and are each assigned to the CPU core statically. In the second embodiment, the application software program group 100 runs on one of the CPU cores 110 and 111, whereas the application software program group 101 works merely on the CPU core 112. The CPU cores 110, 111 and 112 share the cache memory 120, and are linked from the cache memory 120 to the main memory 150 through the system bus 130 and access control device 140.

In the first embodiment, ID of a CPU core is used as the domain ID 421 notified from the CPU core to the cache memory in parallel with a data access request. However, in this embodiment, detection of which application group is the access requester is made possible by providing a domain ID output circuit 600 arranged so that the CPU cores 110 and 111 fixedly output identical ID, and the CPU core 112 outputs an ID different from it as shown in FIG. 8. The other mechanism is arranged in the same way as in the first embodiment. Hence, an unauthorized address-access can be blocked on the cache memory.

What is claimed is:

1. An information processor, on which a plurality of groups of application software programs differing in range of accessible addresses work, comprising:
at least one CPU which runs the application software program groups; and
a cache memory having a judging circuit which accepts an access by the at least one CPU and which judges whether a datum targeted for the access is held or not,
wherein the cache memory holds ID information assigned to each of the application software program groups, and address information corresponding to data stored in the cache memory,
the at least one CPU outputs, to the cache memory, ID information and an access address according to a running application software program of the application software program groups, and
the judging circuit makes a judgment of a cache miss in a case that the access address agrees with an address of data held in the cache memory, however the ID information output by the at least one CPU disagrees with the ID information held by the cache memory.

2. The information processor according to claim 1, wherein the cache memory has a plurality of entries,
each entry has the ID information, the address information and a V-bit showing whether the data stored in the cache memory is valid or not, and
the judging circuit makes the judgment using the ID information, address information and V-bit held by the entry specified by the access address.

3. The information processor according to claim 1, comprising a plurality of CPUs, wherein
the application software program groups are run by the different CPUs, and
the ID information is IDs of the CPUs.

4. The information processor according to claim 1, comprising a plurality of CPUs, wherein
more than one first CPU of the plurality of CPUs runs a first application group of the application software program groups,
at least one second CPU of the plurality of CPUs runs a second application group of the application software program groups,
the more than one first CPU has a first ID-information-output circuit which fixedly outputs first ID information in accessing the cache memory, and
the at least one second CPU has a second ID-information-output circuit which fixedly outputs second ID information differing from the first ID information in accessing the cache memory.
